(19) United States
(12) Patent Application Publication
(10) Pub. No.: US 2013/0293337 A1
(43) Pub. Date: Nov. 7, 2013

(54) HIGH QUALITY FACTOR PLANAR INDUCTORS

(71) Applicants: Chi Shun Lo, San Diego, CA (US); Wesley Nathaniel Allen, Lafayette, IN (US); Jonghae Kim, San Diego, CA (US); Je-Hsiung Jeffrey Lan, San Diego, CA (US); Ravindra V. Shenoy, Dublin, CA (US); Justin Phelps Black, Santa Clara, CA (US); Chengjie Zuo, Santee, CA (US); Changhan Hobie Yun, San Diego, CA (US)

(72) Inventors: Chi Shun Lo, San Diego, CA (US); Wesley Nathaniel Allen, Lafayette, IN (US); Jonghae Kim, San Diego, CA (US); Je-Hsiung Jeffrey Lan, San Diego, CA (US); Ravindra V. Shenoy, Dublin, CA (US); Justin Phelps Black, Santa Clara, CA (US); Chengjie Zuo, Santee, CA (US); Changhan Hobie Yun, San Diego, CA (US)

(73) Assignee: QUALCOMM MEMS TECHNOLOGIES, INC., San Diego, CA (US)

(21) Appl. No.: 13/463,583

(22) Filed: May 3, 2012

(51) Int. Cl. H01F 5/00; H01F 41/04

(52) U.S. Cl. 336/200; 29/602.1

(57) ABSTRACT

This disclosure provides systems, methods, and apparatus related to inductors. In one aspect, a planar inductor may include a substrate with a spacer in the shape of a planar spiral coil on a surface of the substrate. Disposed on the spacer may be a line of metal formed as a planar inductor in the shape of the planar spiral coil. The spacer may be between the line of metal and the surface of the substrate. The spacer may elevate the line of metal above the surface of the substrate.

### TECHNICAL FIELD

This disclosure relates generally to inductors and more particularly to planar inductors having a high quality factor.

### DESCRIPTION OF THE RELATED TECHNOLOGY

Inductors find use in various kinds of circuits, including RF circuits, power-related applications such as transformers, as well as electromechanical systems. Electromechanical systems (EMS) include devices having electrical and mechanical elements, actuators, transducers, sensors, optical components (such as mirrors and optical film layers) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices. Some EMS devices can include or be in electrical communication with inductors.

An inductor is an electrical component that acts to oppose a change of current in an electronic circuit. High Q factor and small form factor inductors may be used where low loss electronic circuits are desirable, including voltage-controlled oscillators (VCOs), low-noise amplifiers (LNAs), impedance matching components, filters (bandpass and notch filters), high and low frequency transformers, power combiners, etc. Other important characteristics of inductors include inductance and resonance frequency.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus including a substrate, a line of metal formed as a planar inductor in a shape of a planar spiral coil, and a spacer in the shape of the planar spiral coil between the line of metal and a surface of the substrate. The line of metal may be disposed on a surface of the spacer, with the spacer elevating the line of metal above the surface of the substrate.

In some implementations, the substrate and the spacer may include a photoimageable glass. In some implementations, the spacer may have a ratio of a height of the spacer to a width of the spacer of about 0.25 to 1 to about 4 to 1. In some implementations, the spacer may have a ratio of a height of the spacer to a width of the spacer of about 1 to 1 or greater, for example about 2 to 1 to about 4 to 1.

Another innovative aspect of the subject matter described in this disclosure can be implemented in an apparatus including a substrate and a line of metal formed on the substrate as a planar inductor in a shape of a planar spiral coil. The line of metal may have a ratio of a height of the line of metal to a width of the line of metal of at least about 10 to 1.

In some implementations, the substrate may include a photoimageable glass. In some implementations, the width of the line of metal may be about 10 microns to 30 microns and the height of the line of metal may be about 100 microns to 300 microns.

Another innovative aspect of the subject matter described in this disclosure can be implemented in a method including patterning a design in a surface of a substrate. The design may define a trench in a shape of a planar spiral coil. A line of metal may be formed in the trench. Portions of the substrate exposed by the line of metal may be removed to form a spacer in the shape of the planar spiral coil. The line of metal may be disposed on a surface of the spacer. The spacer may elevate the line of metal above the surface of the substrate.

In some implementations, forming the line of metal in the trench may include depositing a seed layer on surfaces of the substrate defining the trench and electroplating a metal onto the seed layer. In some implementations, the substrate may include a photoimageable glass substrate. Removing portions of the substrate to form a spacer may include exposing the portions of the substrate exposed by the line of metal to ultraviolet light, exposing the substrate to an elevated temperature, and etching the portions of the substrate exposed by the line of metal.

Another innovative aspect of the subject matter described in this disclosure can be implemented in a method including forming a dielectric layer on a surface of a substrate, forming a metal layer on the dielectric layer, and patterning a design in the metal layer and the dielectric layer. The design may include a shape of a planar spiral coil, with the dielectric layer forming a spacer. The spacer may elevate a line of metal formed by the metal layer above the surface of the substrate.

In some implementations, forming a dielectric layer on a surface of a substrate may include a spin coating process, a physical vapor deposition process, or a chemical vapor deposition process.

Another innovative aspect of the subject matter described in this disclosure can be implemented in a method including patterning a design in a surface of a substrate, the design defining a trench in a shape of a planar spiral coil, and forming a line of metal in the trench.

In some implementations, the substrate includes a photoimageable glass substrate. In some implementations, the line of metal has a ratio of a height of the line of metal to a width of the line of metal of about 1 to 1 or greater.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1A and 1B show examples of schematic illustrations of a planar inductor.

FIGS. 2 and 3 show examples of cross-sectional schematic illustrations of planar inductors.

FIGS. 4A and 4B show examples of schematic illustrations of a planar inductor.

FIG. 5 shows an example of a cross-sectional schematic illustration of a planar inductor.

FIG. 6 shows an example of a flow diagram illustrating a manufacturing process for a planar inductor.

FIGS. 7A-7C show examples of cross-sectional schematic illustrations of a planar inductor in various stages of the manufacturing process shown in FIG. 6.

FIG. 8 shows an example of a flow diagram illustrating another manufacturing process for a planar inductor.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that incorporates an inductor, for example, high Q inductors or inductors or other passives built on glass substrates. Glass has a low loss tangent and high resistivity which makes it a useful substrate for high Q inductors. Furthermore, large area glass substrates are now available for manufacturing passive components (inductors, resistors, capacitors, etc.), allowing for large substrate processes for reduced cost. It is contemplated that the described implementations may be included in or associated with a variety of electronic devices where passive components, particularly inductors, may be useful, such as, but not limited to: RF circuits, bandpass and notch filters, high and low frequency tranformers, power combiners, mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Some implementations described herein relate to planar inductors and methods of their fabrication. For example, in some implementations, a planar inductor may include a substrate. The substrate may include a spacer in the shape of a planar spiral coil. On the spacer may be a line of metal formed as a planar inductor in the shape of the planar spiral coil. The spacer may be between the line of metal and a surface of the substrate. The spacer may elevate the line of metal above the surface of the substrate. In some implementations, the spacer may be the same material as the material of the substrate. In some other implementations, the spacer may include a dielectric material, with the dielectric material being a different material than a material of the substrate.

Particular implementations of the subject matter described in this disclosure can be implemented to realize one or more of the following potential advantages. Implementations of planar inductors including a spacer between the metal of the inductor and the substrate may have a reduced turn-to-turn parasitic capacitance compared to an inductor not including a spacer. This may improve the quality factor of the inductor at certain frequencies, such as high frequencies, for example. Also, the inductor self-resonance frequency may increase.

As noted above, high quality factor planar inductors may be used in a variety of different electronic circuits. In some inductors, the quality factor of the inductor may be inversely proportional to the power loss of the inductor. Loss mechanisms in a planar inductor may include eddy currents induced in the substrate, metal losses due to the resistance of the metal of the inductor, and parasitic capacitance.

The quality factor and resonance frequency of a planar inductor may be improved by reducing the parasitic capacitance of the inductor, without sacrificing the inductance. One source of parasitic capacitance may be due to the electric field between the turns of the line of metal of the planar inductor being at different potentials. One way in which to possibly reduce the parasitic capacitance, as described herein, is to include a spacer between the metal line of the planar inductor and the substrate. Including a spacer may remove material from between the turns of the line of metal of a planar inductor.

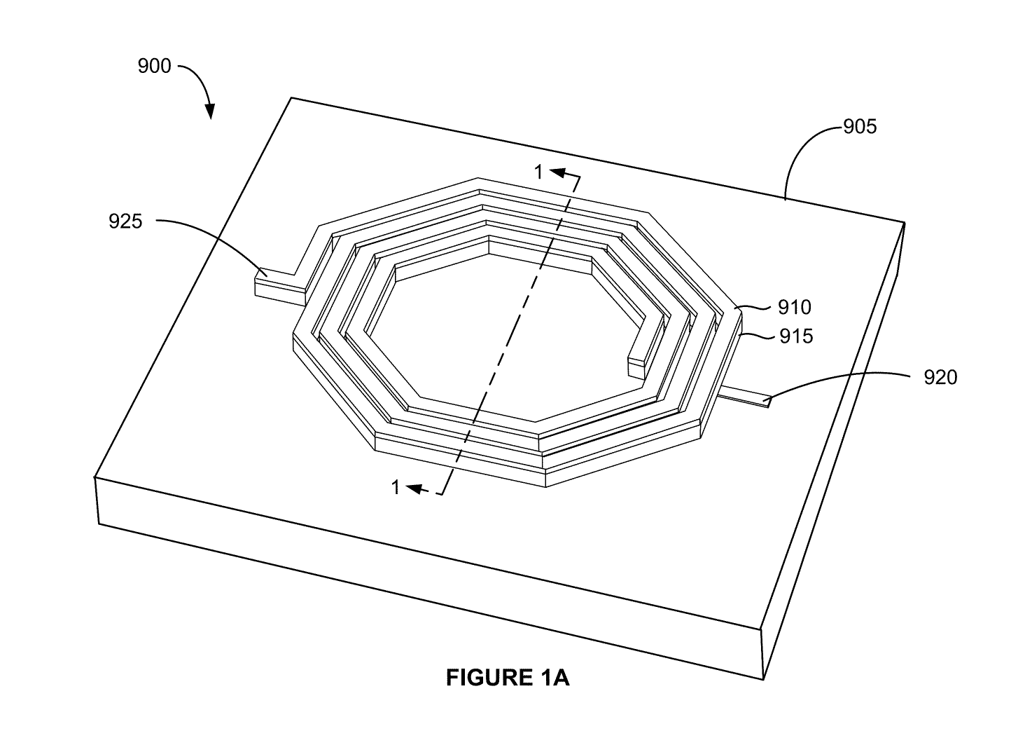

FIGS. 1A and 1B show examples of schematic illustrations of a planar inductor. FIG. 1A shows an example of an isometric projection of a planar inductor. FIG. 1B shows an example of a cross-sectional schematic illustration of a planar inductor through line 1-1 in the isometric projection shown in FIG. 1A. The planar inductor shown in FIGS. 1A and 1B is a 3.5 turn planar inductor.

As shown in FIGS. 1A and 1B, a planar inductor 900 includes a substrate 905, a line of metal 910 formed as an inductor in a shape of a planar spiral coil, and a spacer 915. The substrate 905 may be any number of different substrate materials, including transparent materials and non-transparent materials. In some implementations, the substrate may be silicon (Si), high resistivity silicon (HRS), silicon-on-insulator (SOI), silicon germanium (SiGe), indium phosphide (InP), gallium arsenide (GaAs), silicon carbide (SiC), a glass (such as a display glass, a borosilicate glass, or a photoimageable glass), or a flexible plastic. In some implementations, the substrate may have a surface area of tens of microns by tens of microns to tens or centimeters by tens of centimeters, or even larger. In some implementations, the substrate may have a thickness of a few microns to hundreds of microns, or even thicker.

The line of metal 910 of the planar inductor 900 may have a first end and a second end. That is, the inner loop of the line of metal 910 in the shape of the planar spiral coil may be electrically connected to a first contact 920. The outer loop of the line of metal 910 in the shape of the planar spiral coil may include a second contact 925. In some implementations, the first contact 920 and the second contact 925 may be positioned such that electrical contact may be made with the first contact 920 and the second contact 925. The first contact 920 and the second contact 925 may be used in integrating the planar inductor 900 in an electrical circuit, for example. The metal of the line of metal 910 may be any number of different metals. In some implementations, the metal may include aluminum (Al), an aluminum copper (AlCu) alloy, an aluminum silicon (AlSi) alloy, or copper (Cu).

The line of metal 910 of the planar inductor 900 may be disposed on a surface of the spacer 915. That is, the spacer 915 may be between the substrate 905 and the line of metal 910, with the spacer 915 elevating the line of metal 910 above the surface of the substrate 905. As shown in FIG. 1B, the spacer 915 and the line of metal 910 on the surface of the spacer may define a trench 930 between sections of the spacer 915 and the line of metal 910.

The spacer 915 may be any number of different dielectric materials. In some implementations, the spacer 915 may include SiO₂, SiON, silicon nitride (Si₃N₄), a polyimide, a benzocyclobutene (BCB) based polymer, an acrylic, or other organic-based dielectric material. In some implementations, the spacer 915 may include a dielectric material with a low dielectric constant or a dielectric material with a high resistivity. In some implementations, the dielectric material of the spacer 915 may be a different material than a material of the substrate 905. In some implementations, a height 935 of the spacer 915 may be about 2 microns to 40 microns. In some implementations, the parasitic capacitance may be further reduced with a greater height 935 of the spacer 915. In some implementations, however, spacers having a large height may be difficult to process. In some implementations, a width 940 of the spacer 915 may be about 2 microns to 32 microns. In some implementations, the spacer 915 may have an aspect ratio (that is, a ratio of the height of the spacer to the width of the spacer) of about 0.25 to 1 to about 4 to 1. In some implementations, the spacer may have a ratio of a height of the spacer to a width of the spacer of about 1 to 1 or greater, for example about 2 to 1 to about 4 to 1.

In some implementations, a width 940 of sections of the line of metal 910 on the spacer 915 may be about 2 microns to 32 microns, or about the width 940 of the spacer 915. In some implementations, a height or thickness 945 of the line of metal 910 on the spacer 915 may be about 1 micron to 12 microns. In some implementations, a line to line spacing 950 between sections of the line of metal 910 may be about 1 micron to 20 microns. Similarly, in some implementations the dimension 950 also may be a width of the trench 930.

The planar spiral coil of the planar inductor 900 may have an inner diameter 955 of about 20 microns to 2000 microns and an outer diameter 960 of about 20 microns to 2000 microns. The inner diameter 955 is smaller than the outer diameter 960. While the planar inductor 900 shown in FIGS. 1A and 1B is a 3.5 turn planar inductor (that is, the spiral coil of the planar inductor 900 includes 3.5 turns), about 1.5 turn to 20 turn planar inductors also may be fabricated. For example, the planar inductor may be a 3.2 turn planar inductor.

The line of metal 910 and the spacer 915 in the shape of a planar spiral coil of the planar inductor 900 may be shaped substantially as an octagon, as shown in FIG. 1A. In some other implementations, the line of metal 910 and the spacer 915 in the shape of a planar spiral coil of the planar inductor 900 may be shaped substantially as a hexagon, a polygon having more than six sides, or a circle. Other polygonal and non-polygonal shapes are also possible. Thus, while the term planar spiral coil is used herein to describe implementations of planar inductors, a planar spiral coil need not be circular, and may have any number of different shapes.

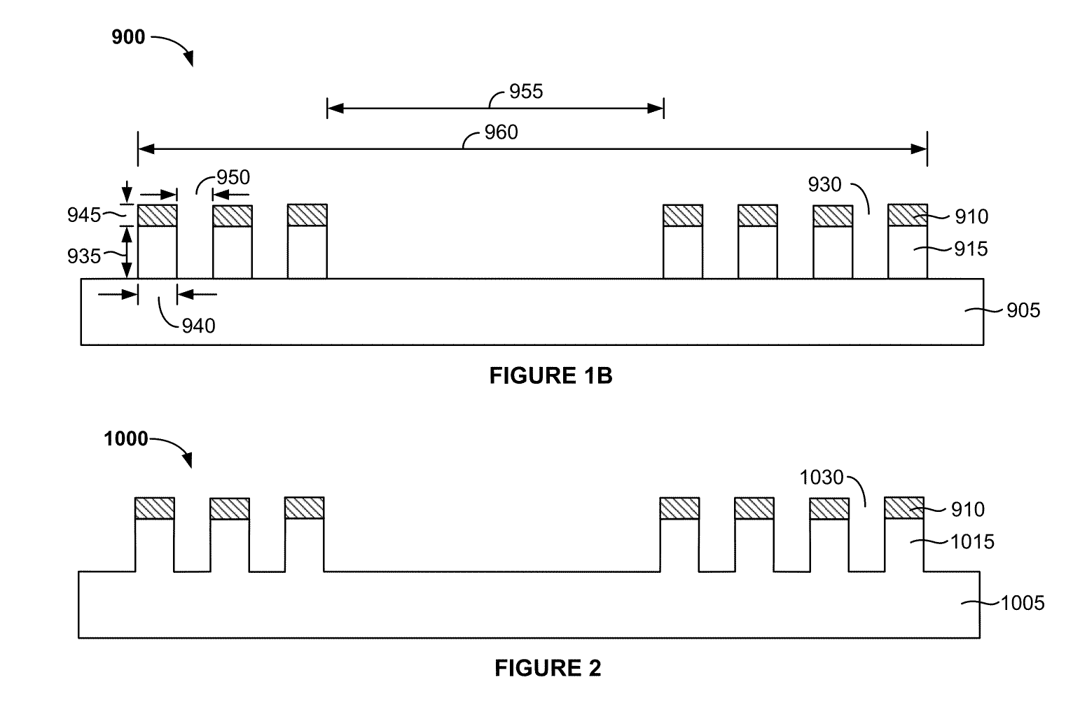

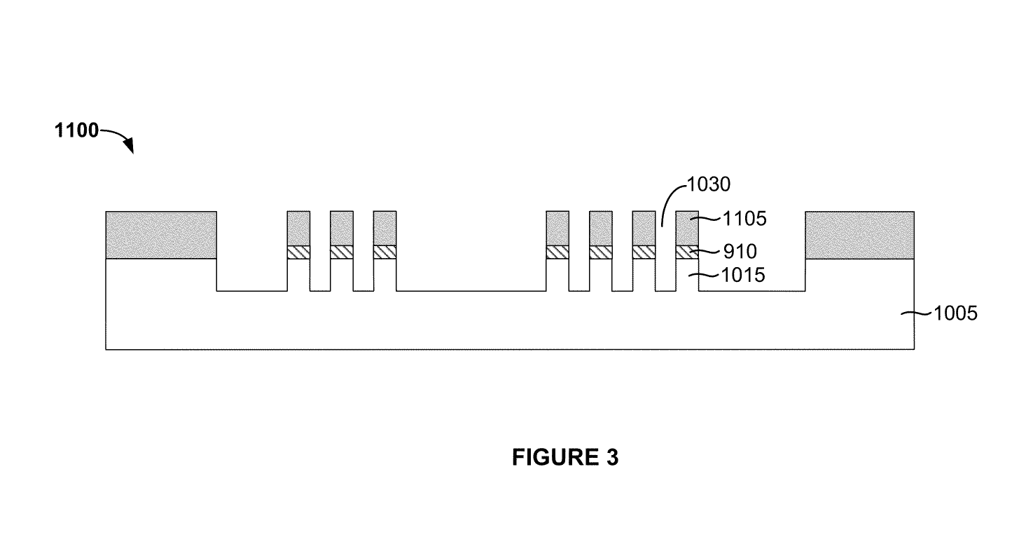

FIGS. 2 and 3 show examples of cross-sectional schematic illustrations of planar inductors. Turning first to FIG. 2, a planar inductor 1000 shown in FIG. 2 may be similar to the planar inductor 900 shown in FIGS. 1A and 1B, with one difference being that the spacer of the planar inductor 1000 is the same material as the material of the substrate. In some implementations, the dimensions of and the materials included in the planar inductor 1000 shown in FIG. 2 may be similar to the dimensions of and the materials included in the planar inductor 900 shown in FIGS. 1A and 1B.

For example, the planar inductor 1000 shown in FIG. 2 includes a substrate 1005, a line of metal 910 formed as an inductor in a shape of a planar spiral coil, and a spacer 1015. The substrate 1005 may be any number of different substrate materials, including transparent materials and non-transparent materials. In some implementations, the substrate may be Si, high resistivity silicon (HRS), silicon-on-insulator (SOI), SiGe, InP, GaAs, SiC, a glass (such as a display glass, a borosilicate glass, or a photoimageable glass), or a flexible plastic. The metal of the line of metal 910 may be any number of different metals. In some implementations, the metal may include Al, an AlCu alloy, an AlSi alloy, or Cu.

The line of metal 910 of the planar inductor 1000 may be disposed on a surface of the spacer 1015. That is, the spacer 1015 may be between the substrate 1005 and the line of metal 910, with the spacer 1015 elevating the line of metal 910 above the surface of the substrate 1005. The spacer 1015 and the line of metal 910 on the surface of the spacer may define a trench 1030 between sections of the spacer 1015 and the line of metal 910. As noted above, the spacer 1015 may be the same material as the substrate 1005. That is, in some implementations, the spacer 1015 may be Si, high resistivity silicon (HRS), silicon-on-insulator (SOI), SiGe, InP, GaAs, SiC, a glass (such as a display glass, a borosilicate glass, or a photoimageable glass), or a flexible plastic.

Fabrication methods of the planar inductor 900 and the planar inductor 1000 are discussed below.

Turning now to FIG. 3, a planar inductor 1100 shown in FIG. 3 may be similar to the planar inductor 1000 shown in FIG. 2, with one difference being that the planar inductor 1100 includes a dielectric layer 1105. For example, the planar inductor 1100 shown in FIG. 3 includes a substrate 1005, a line of metal 910 formed as an inductor in a shape of a planar spiral coil, a spacer 1015, and a dielectric layer 1105 formed over the line of metal 910. The substrate 1005 may be any number of different substrate materials, including transparent materials and non-transparent materials. In some implementations, the substrate may be Si, high resistivity silicon (HRS), silicon-on-insulator (SOI), SiGe, InP, GaAs, SiC, a glass (such as a display glass, a borosilicate glass, or a photoimageable glass), or a flexible plastic. The metal of the line of metal 910 may be any number of different metals. In some implementations, the metal may include Al, an AlCu alloy, an AlSi alloy, or Cu.

The line of metal 910 of the planar inductor 1100 may be disposed on a surface of the spacer 1015. That is, the spacer 1015 may be between the substrate 1005 and the line of metal 910, with the spacer 1015 elevating the line of metal 910 above the surface of the substrate 1005. The spacer 1015 and the line of metal 910 on the surface of the spacer may define a trench 1030 between sections of the spacer 1015 and the line of metal 910.

The dielectric layer 1105 may be used with packaging or packaging layers (not shown) of the planar inductor 1100. As shown, the dielectric layer 1105 is disposed on the line of metal 910 and other portions of the substrate 1005. The dielectric layer 1105 is not in the trench 1030. The dielectric layer 1105 not being in the trench 1030 may aid in maintaining a low parasitic capacitance of the planar inductor 1100. The dielectric layer 1105 may be any number of different dielectric materials. In some implementations, the dielectric layer 1105 may include SiO₂, SiON, Si₃N₄, a polyimide, a benzocyclobutene (BCB) based polymer, an acrylic, or other organic-based dielectric material. In some implementations, the dielectric layer 1105 may include a dielectric material with a low dielectric constant or a dielectric material with a high resistivity.

The dimensions of the dielectric layer 1105 may be similar to the dimensions of the spacer 905 described above with reference to FIGS. 1A and 1B. For example, in some implementations, a height of the dielectric layer 1105 may be about 2 microns to 40 microns. In some implementations, a width of the dielectric layer 1105 may be about 2 microns to 32 microns, or the width of the dielectric layer 1105 may be about the same as the width of a section of the line of metal 910. In some implementations, the dielectric layer 1105 may have an aspect ratio (that is, a ratio of the height of the dielectric layer to the width of the dielectric layer) of about 0.25 to 1 to about 4 to 1. In some implementations, the dielectric layer 1105 may have a ratio of a height of the spacer to a width of the spacer of about 1 to 1 or greater, for example about 2 to 1 to about 4 to 1.

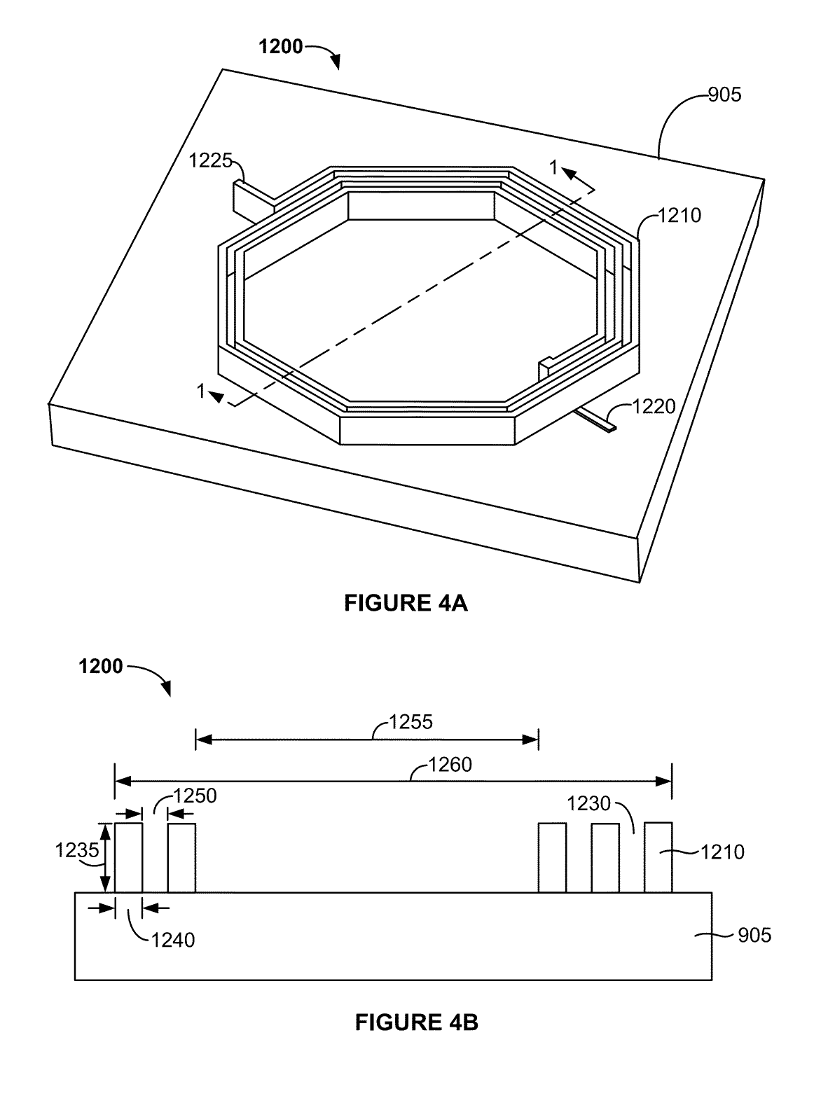

FIGS. 4A and 4B show examples of schematic illustrations of a planar inductor. FIG. 4A shows an example of an isometric projection of a planar inductor. FIG. 4B shows an example of a cross-sectional schematic illustration of a planar inductor through line 1-1 in the isometric projection shown in FIG. 4A. The planar inductor shown in FIGS. 4A and 4B is a 2.5 turn planar inductor.

As shown in FIGS. 4A and 4B, a planar inductor 1200 includes a substrate 905 and a line of metal 1210 formed as an inductor in a shape of a planar spiral coil. The substrate 905 may be any number of different substrate materials, including transparent materials and non-transparent materials. In some implementations, the substrate may be Si, high resistivity silicon (HRS), silicon-on-insulator (SOI), SiGe, InP, GaAs, SiC, a glass (such as a display glass, a borosilicate glass, or a photoimageable glass), or a flexible plastic. In some implementations, the substrate may have dimensions of a few microns to hundreds of microns.

The line of metal 1210 of the planar inductor 1200 may have a first end and a second end. That is, the inner loop of the line of metal 1210 in the shape of the planar spiral coil may be electrically connected to a first contact 1220. The outer loop of the line of metal 1210 in the shape of the planar spiral coil may include a second contact 1225. In some implementations, the first contact 1220 and the second contact 1225 may be positioned such that electrical contact may be made with the first contact 1220 and the second contact 1225. The first contact 1220 and the second contact 1225 may be used in integrating the planar inductor 1200 in an electrical circuit, for example. The metal of the line of metal 1210 may be any number of different metals. In some implementations, the metal may include Al, an AlCu alloy, an AlSi alloy, or Cu.

In some implementations, a width 1240 of sections of the line of metal 1210 may be about 10 microns to 30 microns or about 20 microns to 30 microns. In some implementations, a height 1235 of sections of the line of metal 1210 may be about 100 microns to 300 microns or about 200 microns to 300 microns. In some implementations, a line to line spacing 1250 between sections of the line of metal 1210 may be about 5 microns to 15 microns, or about 10 microns.

In some implementations, the line of metal 1210 may have an aspect ratio (that is, a ratio of the height of the line of metal to the width of the line of metal) of at least about 10 to 1, or about 10 to 1 to about 20 to 1. In some implementations, the line of metal 1210 having a high aspect ratio may reduce metal losses in the planar inductor 1200.

The planar spiral coil of the planar inductor 1200 may have an inner diameter 1255 of about 20 microns to 2000 microns and an outer diameter 1260 of about 20 microns to 2000 microns. The inner diameter 1255 is smaller than the outer diameter 1260. While the planar inductor shown in FIGS. 4A and 4B is a 2.5 turn planar inductor, about 1.5 turn to 20 turn planar inductors also may be fabricated.

The line of metal 1210 in the shape of a planar spiral coil of the planar inductor 1200 may be shaped substantially as an octagon, as shown in FIG. 4A. In some other implementations, the line of metal 1210 in the shape of a planar spiral coil of the planar inductor 1200 may be shaped substantially as a hexagon, a polygon having more than six sides, or a circle. Other polygonal and non-polygonal shapes are also possible.

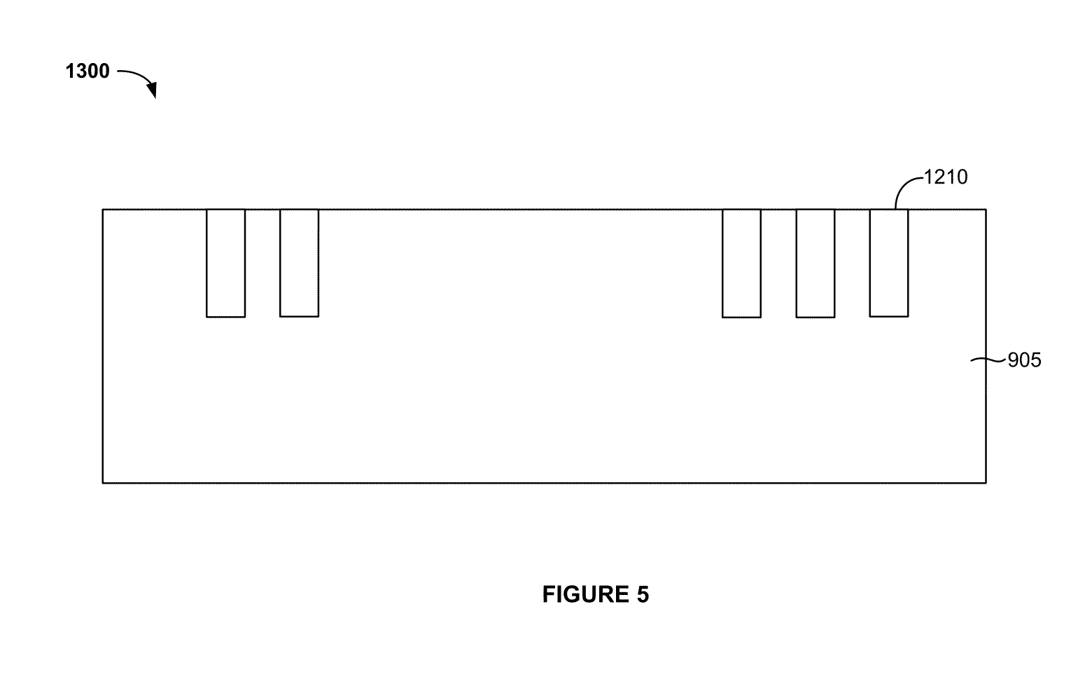

FIG. 5 shows an example of a cross-sectional schematic illustration of a planar inductor. A planar inductor 1300 shown in FIG. 5 may be similar to the planar inductor 1200 shown in FIGS. 4A and 4B, with one difference being that the material of the substrate is included between sections of the line of metal in the planar inductor 1300. In some implementations, the dimensions of and the materials included in the planar inductor 1300 shown in FIG. 5 may be similar to the dimensions of and the materials included in the planar inductor 1200 shown in FIGS. 4A and 4B.

The planar inductor 1300 shown in FIG. 5 includes a substrate 905 and a line of metal 1210 formed as an inductor in a shape of a planar spiral coil. The substrate 905 may be any number of different substrate materials, including transparent materials and non-transparent materials. In some implementations, the substrate may be Si, high resistivity silicon (HRS), silicon-on-insulator (SOI), SiGe, InP, GaAs, SiC, a glass (such as a display glass, a borosilicate glass, or a photoimageable glass), or a flexible plastic. The metal of the line of metal 1210 may be any number of different metals. In some implementations, the metal may include Al, an AlCu alloy, an AlSi alloy, or Cu. In some implementations, the line of metal 1210 of the planar inductor 1300 may have an aspect ratio (that is, a ratio of the height of the line of metal to the width of the line of metal) of at least about 10 to 1, or about 10 to 1 to about 20 to 1. In some implementations, the line of metal 1210 having a high aspect ratio may reduce metal losses in the planar inductor 1300.

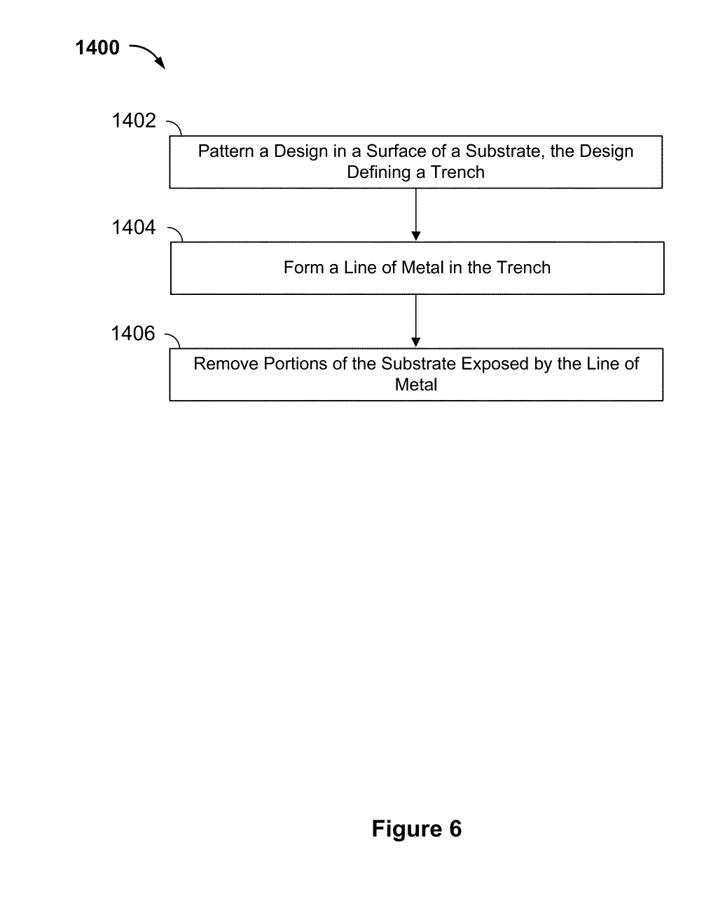

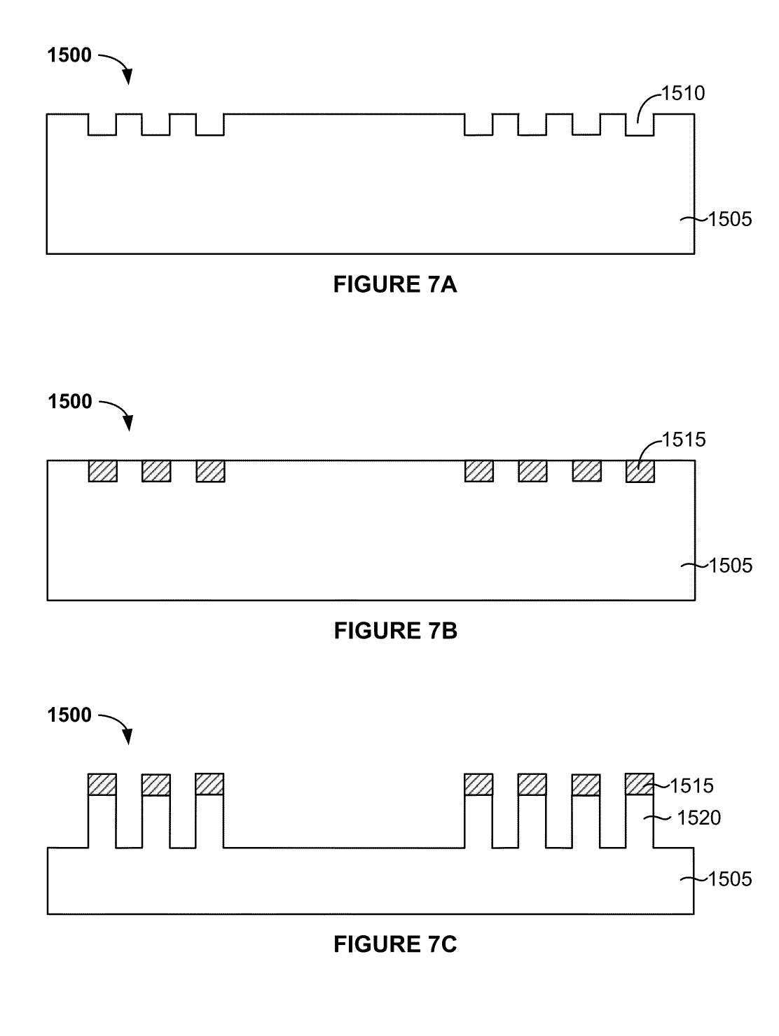

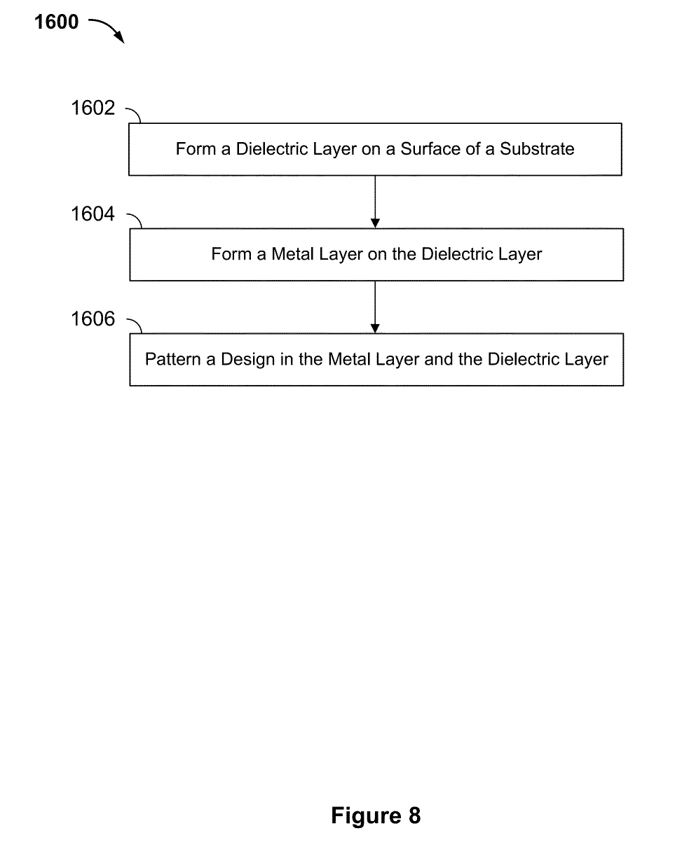

FIG. 6 shows an example of a flow diagram illustrating a manufacturing process for a planar inductor. FIGS. 7A-7C show examples of cross-sectional schematic illustrations of a planar inductor in various stages of the manufacturing process shown in FIG. 6. In some implementations, a process 1400 shown in FIG. 6 may be used to fabricate a planar inductor similar to the planar inductor 1000 shown in FIG. 2. FIG. 8 shows an example of a flow diagram illustrating another manufacturing process for a planar inductor. In some implementations, a process 1600 shown in FIG. 8 may be used to fabricate a planar inductor similar to the planar inductor 900 shown in FIGS. 1A and 1B.

Manufacturing processes for planar inductors can be viewed as subtractive processes or additive processes. An example of a subtractive process for the metal of a planar inductor is a process in which a layer of metal (for example, Al or an Al alloy) is deposited (for example, by sputter deposition) onto a substrate. The metal may then be patterned and etched to form a planar spiral coil, for example. An example of an additive process for the metal of a planar inductor is a process in which a seed layer (for example, a Cu seed layer) is deposited (for example, by evaporation, sputter deposition, or electroless plating) onto a substrate. A photoresist may be deposited over the seed layer and a pattern of a planar spiral coil may be formed in the photoresist. A metal (for example, Cu) may be electroplated within the pattern of the planar spiral coil on exposed portions of the seed layer. After the photoresist is removed, the seed layer remaining on the substrate (i.e., seed layer not electroplated onto) may be removed using an etching process, for example. Similarly, the spacer in some of the described inductors (see, for example, FIGS. 1A, 1B, and 2) can be manufactured using subtractive process (for example, etching a dielectric layer disposed on a substrate) or using additive processes.

Turning first to FIG. 6, at block 1402 of the process 1400, a design is patterned in a surface of a substrate. In some implementations, the design may define a trench in a shape of a planar spiral coil. The trench may further include a first end and a second end. Depending on the material of the substrate, different processes may be used to pattern the design in the surface of the substrate.

In some implementations, when the substrate is photoimageable glass, the substrate may be exposed to ultraviolet light in regions where the design is being formed and then exposed to an elevated temperature. The design then may be etched in the photoimageable glass substrate. In some other implementations, the design may be patterned in the surface of the substrate with an etching process, a reactive-ion etching (RIE) process, or a laser ablation process.

FIG. 7A shows an example of a cross-sectional schematic illustration of a partially fabricated planar inductor 1500 at this point (for example, up through block 1402) in the process 1400. The partially fabricated planar inductor 1500 includes a substrate 1505 that defines a trench 1510 of a design that has been patterned in the surface of the substrate 1505.

At block 1404, a line of metal may be formed in the trench. Any number of different processes may be used to form the line of metal. In some implementations, the line of metal may be formed with a PVD process or a chemical vapor deposition (CVD) process. In some other implementations, the line of metal may be formed with a plating process. For example, a seed layer first may be deposited on surfaces of the substrate defining the trench with a PVD process, a CVD process, or an atomic layer deposition process (ALD) process. Then, a metal may be electroplated onto the seed layer.

In some implementations, the metal may be formed in the trench and on areas of the surface of the substrate adjacent to the trench. The metal may be removed from the areas of the surface of the substrate adjacent to the trench with a chemical-mechanical polishing (CMP) process, for example.

FIG. 7B shows an example of a cross-sectional schematic illustration of the partially fabricated planar inductor 1500 at this point (for example, up through block 1404) in the process 1400. The partially fabricated planar inductor 1500 includes the substrate 1505 and a line of metal 1515 in the trench of a design that has been patterned in the surface of the substrate 1505.

At block 1406, portions of the substrate exposed by the line of metal are removed to form a spacer in the shape of the planar spiral coil. The line of metal may be disposed on a surface of the spacer. The spacer may elevate the line of metal above the surface of the substrate. Depending on the material of the substrate, different processes may be used to remove the portions of the substrate exposed by the line of metal.

In some implementations, when the substrate is photoimageable glass, the substrate may be exposed to ultraviolet light. The line of metal may act as a mask, and the portions of the substrate exposed by the line of metal may be exposed to ultraviolet light. The substrate may then be exposed to an elevated temperature. Subsequently, the portions of the substrate may be removed with an etching process. In some other implementations, the portions of the substrate exposed by the line of metal may be removed with an etching process, a reactive-ion etching (RIE) process, or a laser ablation process. In some implementations, the line of metal also may act as a mask in an etching process, a reactive-ion etching (RIE) process, or a laser ablation process.

FIG. 7C shows an example of a cross-sectional schematic illustration of the fabricated planar inductor 1500 at this point (for example, up through block 1406) in the process 1400. The fabricated planar inductor 1500 includes the substrate 1505 including the line of metal 1515 disposed on a spacer 1520. The spacer 1520 is the same material as the material of the substrate 1505. In some implementations, the dimensions of and the materials included in the planar inductor 1500 shown in FIG. 7C may be similar to the dimensions of and the materials included in the planar inductor 1000 shown in FIG. 2. Further, the planar inductor 1100 shown in FIG. 3 can be formed using a process similar to that shown in FIG. 6, but with an added operation that includes adding a dielectric layer over the lines of metal and then patterning any dielectric layer in the trenches to match a pattern of the lines of metal.

Turning next to FIG. 8, the process 1600 shown in FIG. 8 is another manufacturing process for a planar inductor. At block 1602 of the process 1600, a dielectric layer is formed on a surface of a substrate. A process used to form the dielectric layer may depend on the material of the dielectric layer. For example, a spin coating process, a PVD process, or a CVD process may be used to form the dielectric layer.

At block 1604, a metal layer is formed on the dielectric layer. Any number of different processes may be used to form the metal layer. In some implementations, the metal layer may be formed with a PVD process or a CVD process. In some other implementations, the metal layer may be formed with a plating process. For example, a seed layer first may be deposited on the surface of the dielectric layer with a PVD process, a CVD process, or an ALD process. Then, a metal may be electroplated onto the seed layer.

At block 1606, a design is patterned in the metal layer and the dielectric layer. This may form a line of the dielectric layer elevating a line of metal above the surface of the substrate. The design may include a shape of a planar spiral coil, with the dielectric layer forming a spacer elevating the line of metal formed by the metal layer above the surface of the substrate. Different processes may be used to pattern the design in the metal layer and the dielectric layer. In some implementations, the design may be patterned in the metal layer and the dielectric layer with an etching process, a reactive-ion etching (RIE) process, or a laser ablation process. In some implementations, the design may be patterned in the metal layer with a process, and the the design may be patterned in the dielectric layer with the same process. Patterning the dielectric layer may occur immediately after patterning the metal layer when patterning the metal layer and the dielectric layer using the same process. In some other implementations, the design may be first patterned in the metal layer with one process, and then the design may be patterned in the dielectric layer with another process.

Note that the operations of the processes 1400 and 1600 may be combined and/or rearranged to fabricate any of the planar inductors disclosed herein. For example, another process to fabricate a planar inductor similar to the planar inductor 1000 shown in FIG. 2 may include forming a layer of metal on a surface of a substrate, and then patterning a design in the metal layer and the substrate. This process may form a spacer made of the material of the substrate, with the spacer elevating a line of metal formed by the layer of metal above the surface of the substrate.

As another example, a planar inductor similar to the planar inductor 1300 shown in FIG. 5 may be fabricated with the operations of blocks 1402 and 1404 of the process 1400 shown in FIG. 6. In some implementations, with high aspect ratio metal lines, the trenches formed in block 1402 can be high aspect ratio trenches. In some implementations, the trenches may be formed in a photoimageable glass. Metal may then be plated onto a seed layer deposited on surfaces of the substrate defining the trench or deposited in the trench using another method, similar to block 1404.

In some implementations, after a planar inductor similar to the planar inductor 1300 shown in FIG. 5 is fabricated, a planar inductor similar to the planar inductor 1200 shown in FIGS. 4A and 4B may be fabricated by removing the substrate material from between sections of the line of metal.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus. If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blue-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a substrate;
a line of metal formed as a planar inductor in a shape of a planar spiral coil; and
a spacer in the shape of the planar spiral coil between the line of metal and a surface of the substrate, the line of metal being disposed on a surface of the spacer, the spacer elevating the line of metal above the surface of the substrate.

2. The apparatus of claim 1, wherein the spacer includes a dielectric material, the dielectric material being a different material than a material of the substrate.

3. The apparatus of claim 1, wherein the spacer is the same material as a material of the substrate.

4. The apparatus of claim 1, wherein the substrate and the spacer include a photoimageable glass.

5. The apparatus of claim 1, wherein the spacer and the line of metal define a trench between sections of the spacer and the line of metal.

6. The apparatus of claim 1, wherein a line to line spacing of the line of metal formed in the shape of the planar spiral coil is about 1 micron to 20 microns.

7. The apparatus of claim 1, wherein the spacer has a ratio of a height of the spacer to a width of the spacer of about 1 to 1 or greater.

8. The apparatus of claim 1, wherein a height of the spacer is about 2 microns to 40 microns.

9. The apparatus of claim 1, wherein the line of metal is about 1 micron to 12 microns thick.

10. The apparatus of claim 1, wherein the planar spiral coil has an inner diameter of about 20 microns to 2000 microns and an outer diameter of about 20 microns to 2000 microns.

11. The apparatus of claim 1, wherein the planar spiral coil has about 1.5 turns to 20 turns.

12. An apparatus comprising:
a substrate; and
a line of metal formed on the substrate as a planar inductor in a shape of a planar spiral coil, the line of metal having a ratio of a height of the line of metal to a width of the line of metal of at least about 10 to 1.

13. The apparatus of claim 12, wherein the substrate includes a photoimageable glass.

14. The apparatus of claim 12, wherein the width of the line of metal is about 10 microns to 30 microns, and wherein the height of the line of metal is about 100 microns to 300 microns.

15. The apparatus of claim 12, wherein the line of metal defines a trench between sections of the line of metal.

16. A method comprising:
(a) patterning a design in a surface of a substrate, the design defining a trench in a shape of a planar spiral coil;
(b) forming a line of metal in the trench; and
(c) removing portions of the substrate exposed by the line of metal to form a spacer in the shape of the planar spiral coil, the line of metal being disposed on a surface of the spacer, the spacer elevating the line of metal above the surface of the substrate.

17. The method of claim 16, wherein operation (b) includes:
depositing a seed layer on surfaces of the substrate defining the trench; and
electroplating a metal onto the seed layer.

18. The method of claim 16, wherein the substrate includes a photoimageable glass substrate.

19. The method of claim 18, wherein operation (c) includes:
exposing the portions of the substrate exposed by the line of metal to ultraviolet light;
exposing the substrate to an elevated temperature; and
etching the portions of the substrate exposed by the line of metal.

20. A method comprising:
(a) forming a dielectric layer on a surface of a substrate;
(b) forming a metal layer on the dielectric layer; and
(c) patterning a design in the metal layer and the dielectric layer, the design including a shape of a planar spiral coil, the dielectric layer forming a spacer, the spacer elevating a line of metal formed by the metal layer above the surface of the substrate.

21. The method of claim 20, wherein operation (a) includes at least one of a spin coating process, a physical vapor deposition process, and a chemical vapor deposition process.

22. A method comprising:
(a) patterning a design in a surface of a substrate, the design defining a trench in a shape of a planar spiral coil; and
(b) forming a line of metal in the trench.

23. The method of claim 22, wherein the substrate includes a photoimageable glass substrate.

24. The method of claim 22, wherein the line of metal has a ratio of a height of the line of metal to a width of the line of metal of about 1 to 1 or greater.
